(19) United States
(12) Patent Application Publication
(10) Pub. No.: US 2013/0233391 A1
(43) Pub. Date: Sep. 12, 2013

(54) Secured System and Method for Removal of Oil from an Oil Battery

(71) Applicants: Mike McMillan, Marietta, GA (US); Roger Simmons, Madison, GA (US); John Evans, Sandy Springs, GA (US)

(72) Inventors: Mike McMillan, Marietta, GA (US); Roger Simmons, Madison, GA (US); John Evans, Sandy Springs, GA (US)

(21) Appl. No.: 13/716,143

(22) Filed: Dec. 15, 2012

Related U.S. Application Data
(60) Provisional application No. 61/576,286, filed on Dec. 15, 2011.

(51) Int. Cl. F16K 35/00

(52) U.S. Cl. CPC F16K 35/00
USPC 137/1; 137/384.2

(57) ABSTRACT

A method of providing access to an oil battery having a valve with a valve handle for permitting oil to flow through a pipe for conveyance to a secondary storage vessel. The method includes the following steps: providing a lock inhibiting the movement of said valve handle; providing a identifier identifying which valve is desired access; providing an operator identification identifying an entity seeking access to said valve; determining if said entity seeking access to said valve is authorized to have access; and unlocking said lock enabling said valve to be opened if it is determined that said entity seeking access to said valve is authorized to have access.

### CROSS REFERENCE TO RELATED APPLICATIONS

This application claims priority from provisional filing 61/576,286 entitled Air Activated Electro Mechanical Locking Collar and which is incorporated by reference in its entirety.

### FIELD OF INVENTION

The present invention relates to secured access. More particularly, the present invention relates to the secured access to an oil battery for the authorized removal of oil utilizing an authorization system and corresponding lock.

### BACKGROUND OF THE INVENTION

In the oil industry there are sites called tank batteries where crude oil from producing wells is accumulated, treated, and stored prior to being trucked or piped to the refinery. At a tank battery site, there is equipment that separates or filters contaminants such as sand, water, and natural gas from the crude oil prior to the oil going into large storage tanks. Once the oil is “cleaned” it is sold and moved to the refinery.

A large percentage of crude oil is moved to refineries by truck since most oil production and the associated tank battery sites are in remote areas where pipelines are not accessible. In order for a tanker truck to remove the oil from a tank at a site, the truck pulls up adjacent to the transfer pipe coming out of a crude oil tank, hooks up a flexible hose to the pipe, opens the mechanical valve that controls the flow of oil from the pipe to the truck, and vacuums the oil out of the storage tank.

Due to these tank battery sites being in remote areas where there is little or no security, the oil industry has suffered significant theft of oil from their tank battery sites. Today a typical load of oil in a tanker truck is approximately 170 barrels with a value of over $16,000. None of the sites are attended. Many are not fenced and the ones that are, typically have gates that are not locked. In most cases the transfer valves used to take oil from the storage tanks are not locked or if they are, it is a simple mechanical padlock that can easily be cut off. In some cases combination padlocks are used with widely known access codes. Thieves can steal the oil by simply attaching a hose to a tank truck and opening a mechanical valve. Once they steal the oil, the thieves take the oil to another oil producer that is typically located in the same vicinity and is part of the theft process, and pump the oil into that producer's storage tanks and then split the profit.

It is an object of the present invention to provide a more secure system of oil removal thereby hindering the theft of the oil.

### SUMMARY OF THE INVENTION

A method of providing access to an oil battery is provided. The oil battery includes valves with a valve handle for permitting oil to flow through a pipe for conveyance to a secondary storage vessel. The method includes the following steps: providing a lock inhibiting the movement of the valve handle; providing an identifier identifying which valve is desired access; providing an operator identification identifying an entity seeking access to said valve; determining if said entity seeking access to said valve is authorized to have access; and unlocking said lock enabling said valve to be opened if it is determined that said entity seeking access to said valve is authorized to have access.

### BRIEF DESCRIPTION OF THE DRAWINGS

FIG. 1 is an embodiment of a locking collar according to one embodiment of the present invention;

FIG. 1A illustrates the movement of a mechanical valve from a closed to open position;

FIG. 2 illustrates a locking collar according to one embodiment of the present invention for attachment to a mechanical valve;

FIG. 3 illustrates a locking collar attached to a mechanical valve restricting movement of the mechanical valve according to the present invention;

FIG. 4 is a schematic of a system according to the present invention;

FIG. 5 is a schematic of a controller according to the present invention;

FIG. 6 is a flow chart illustrating the authorization of a locking collar according to the present invention;

FIG. 7 illustrates one example of a locking collar according to the present invention;

FIG. 8 illustrates the internal components of a locking collar according to an additional embodiment according to the present invention; and

FIG. 9 illustrates magnetic arm switches for use with the present invention.

### PREFERRED EMBODIMENT

In the intended environment, a system and method is provided for securing access to oil tanks. In operation, oil transfer pipes are utilized for transferring oil within the tank batteries to trucks. These oil transfer pipes include mechanical valves for opening and closing the respective pipes. The preferred embodiment utilizes a locking collar for preventing movement of the mechanical valve thereby preventing the flow of oil to occur.

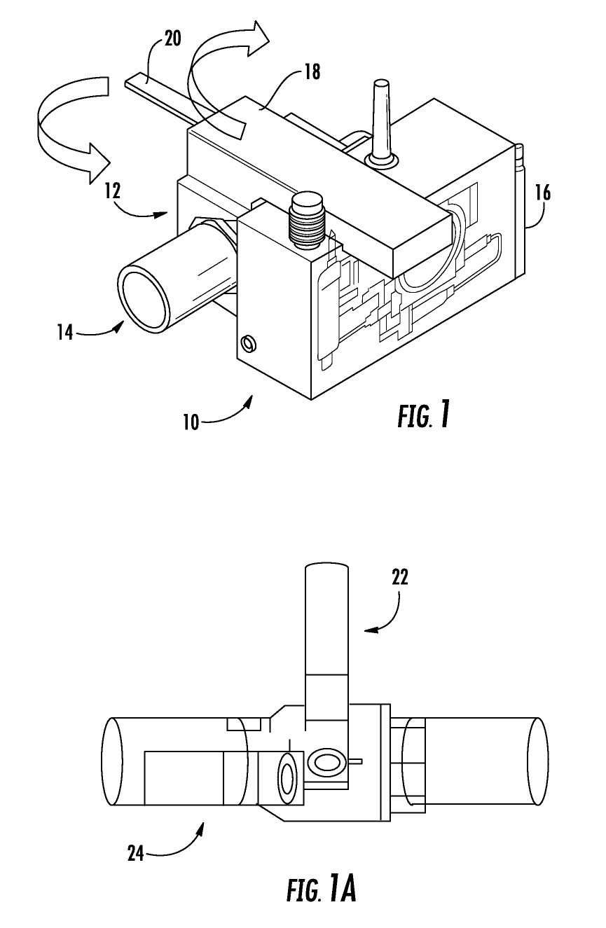

As shown in FIG. 1 a locking collar 10 is integrated to a mechanical valve 12 restricting movement of the mechanical valve to an “Open” position preventing fluid flow to occur through fluid pipe 14. Locking collar 10 preferably includes a primary housing 16 which houses a locking mechanism and an actuator mechanism for releasing a lock. The locking mechanism restricts movement of a valve retainer 18 which preferably encloses mechanical valve handle 20. FIG. 1A illustrates the movement of valve handle 20 from a closed position 22 to an open position 24.

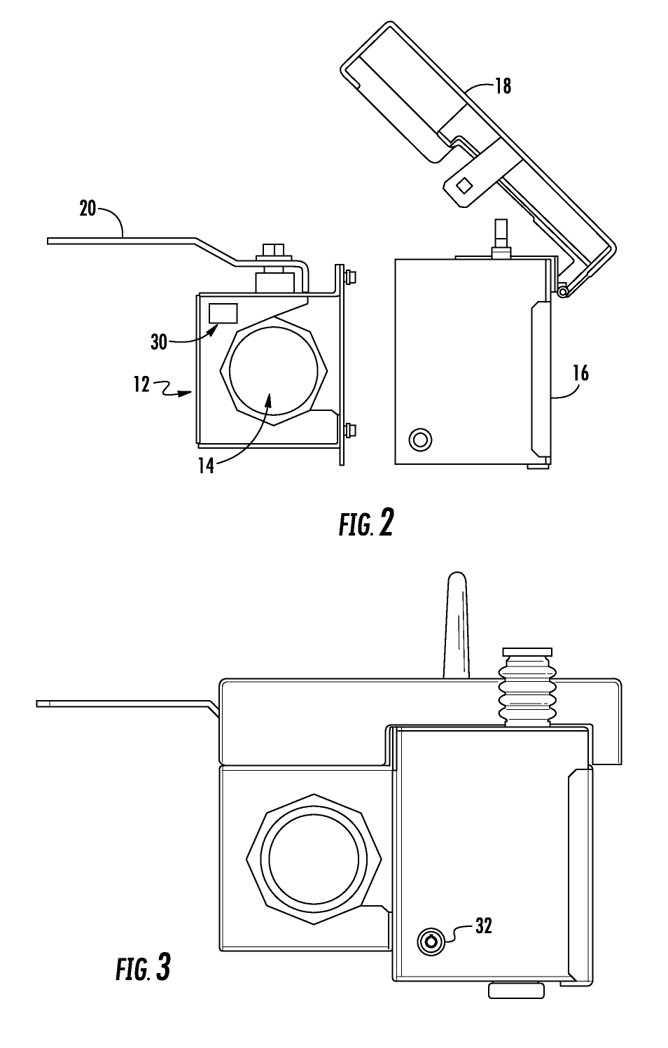

As shown in FIG. 2, locking collar housing 16 is adapted for mating attachment to mechanical valve 12. Valve retainer 18 is pivotally hinged to locking collar housing 16. When the locking mechanism is engaged, valve retainer 18 is locked into a closed position enclosing the mechanical valve. When the locking mechanism is disengaged by the actuator mechanism, the valve retainer may be lifted exposing the mechanical valve handle 20. In the preferred embodiment, mechanical valve 12 includes a valve identifier 30 for identifying the respective valve which access will subsequently be requested and will be discussed in detail.

FIG. 3 illustrates a detailed listing of the components of the locking collar as attached to the mechanical valve. As shown, the mechanical valve retainer is in the closed and locked position. In an additional embodiment, a secondary key insert 32 is shown for receiving a key in the case where the locking collar is not functioning properly. In an embodiment, a key may be locate in a key storage compartment in the vicinity of or carried by the locking collar.

As shown in FIGS. 1-3, a transfer pipe 14 is utilized for transferring oil from an oil reservoir to a truck. A mechanical valve 20 is rotated from a “closed” and “open” position permitting fluid flow to occur throughout transfer pipe 14. The Locking Collar 10 includes a mechanical valve enclosure 16 adapted to enclose the mechanical valve 20 prohibiting movement of the mechanical valve from the “closed” to “open” position. The mechanical valve enclosure is preferably a hinged cover. If the transfer of oil is authorized, the locking collar includes a system for transitioning the mechanical valve enclosure to a second position which enables access to the mechanical valve.

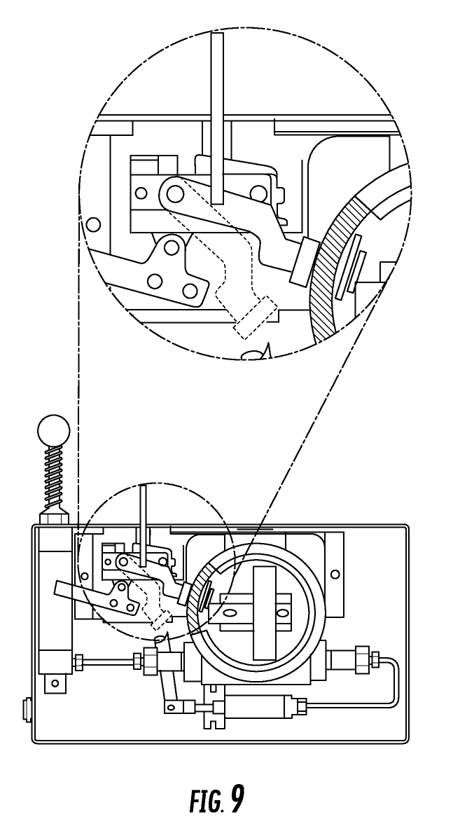

In an embodiment as shown in FIGS. 8 and 9, the locking collar 10 includes four primary components. A general housing 16 encloses the locking system 40 and actuation system 42. An explosion proof solenoid valve 44 is contained within the housing for controlling the operation of the actuation system. In the preferred embodiment, the explosion proof solenoid valve and associated electronics are enclosed within an explosion proof enclosure 50. One such explosion proof solenoid valve is available from Rotex Automation limited. Preferably the electronics operate on twenty-four volts. As shown in FIG. 9, the locking system includes a hasp from the cover which is engaged by the locking mechanism.

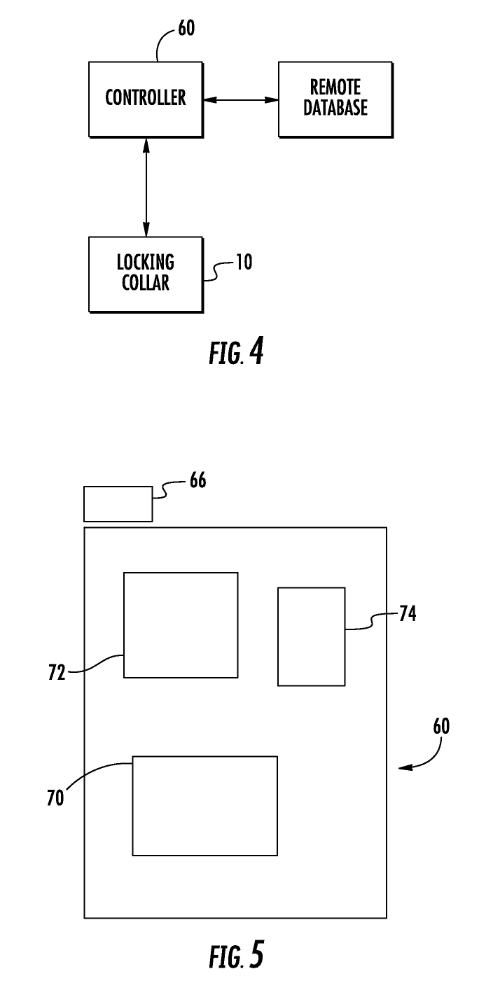

As shown in FIG. 4, the system includes controller 60 which controls the passage of electrical current to the explosion proof solenoid valve located within the housing 30 of the locking collar 10. The provision of the electrical current from the controller to the solenoid valve will result in the actuation system of the locking collar for operating the locking system thereby removing the enclosure from restraining the mechanical valve and enabling the mechanical valve to be moved to an open position.

As shown in FIG. 5, controller 60 includes an antenna 66 communicating with a wireless and/or cellular network for controlling the operation of the solenoid valve of the locking collar depending on if access is granted. Controller 60 includes a central processing unit 70, memory 72 and a regulated electrical source 74. By providing a regulated electrical source, the operating voltage for the solenoid valve is maintained. In the preferred embodiment, as shown in FIG. 74 a controller 60 is located remotely from locking collar 10. In this manner, any electrical spikes in the system are removed from the locking collar and the volatile environment present.

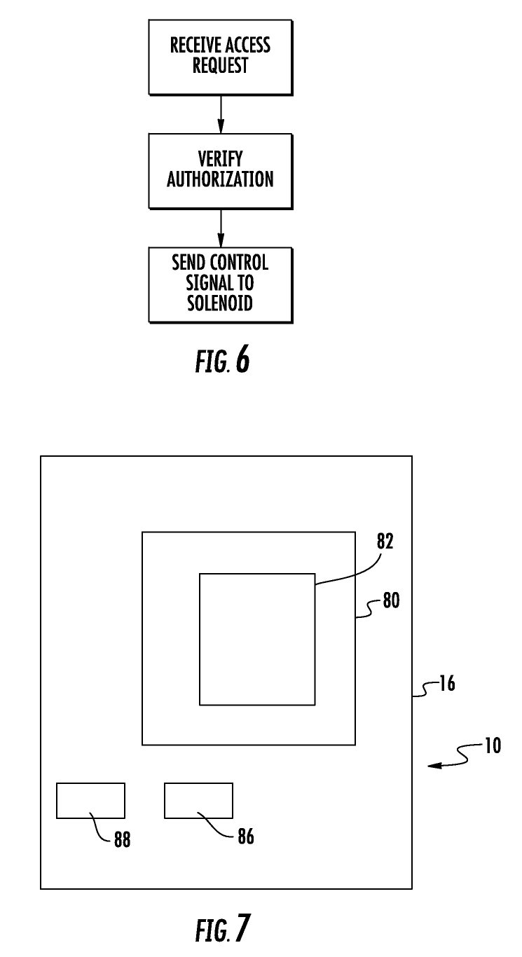

A key aspect of the invention is monitoring and controlling access to the locking collar. In the preferred embodiment, as shown in FIGS. 4 and 6, an access request is sent out by an operator. At a remote site the request is received and a verification process is conducted to determine if the operator requesting access to the mechanical valve for transferring oil from the respective oil tank is authorized. If the operator is authorized, a verification control signal is transmitted to the controller. Upon receipt of the verification control signal, the controller will transmit an operational voltage to the electronic solenoid contained within the locking collar. As will be discussed, the operation of the electronic solenoid valve will result in the locking cover being removed from restraining the mechanical valve.

The request of authorization by the operator may be conducted in several manners. The purpose is to provide a manner to identify which valve access is being sought. For instance: 1) QR Code : A QR code is placed near the valve to be opened. When the person needing access arrives, they use a QR app on their phone to scan the code, which then auto-fills a text message. They click send, then the server determines if they are allowed to open the valve, performs the action if allowed, and sends a text message back indicating the success/failure. In this manner, the QR code is utilized to identify the valve which access is being requested. Utilizing the phone provides an operator identify which is utilized to determine if that operator identity is allowed access to that particular valve associated with the QR. 2) SMS Message: Next to the QR code can be instructions on how to manually enter the text message. It would include our text message server phone number, and the message to send, such as “Lock-Unlock 2245” (Where 2245 is the valve number). The person needing access would send a SMS to the provided number with the provided message. Then the server determines if they are allowed to open the valve, performs the action if allowed, and sends a text message back indicating the success/failure. As with the QR code, the phone would have an associated identifier which is utilized for identifying the identity of the requestor. 3) Keypad A keypad can be located nearby that would guide the user through unlocking the valve. A PIN number would need to have been previously assigned. 4) Website The customer can access a website to view the locked/unlocked status of all valves. From this screen they can also request a remote unlock or lock of any valve. 5) Automated Phone Call Next to the QR code can be instructions to call a phone number. The person needing access to the valve would call the phone number from their cell phone, and enter the code of the valve to be unlocked. This is an automated system, so they would be walked through the process and would be told if their action was successful or failed. 6) Others means may include RFID cards, iButton keys, custom radio “garage door openers”, having a push button near the well that would send a request to a central office were they can use the camera to verify then open the valve.

Some systems would include a Phone Number Requirement procedure wherein a cell phone number would need to be entered into a database for QR, SMS or Phone Calls to work . Keypad access would require a previously assigned (by company or their vendor) PIN code. Website Access would require either the company login or a vendor login if applicable.

In operation, the individual requesting access must have a predefined identifier which may include a phone number, a PIN number or a website login. The identifier will be associated with respective valves. The valves themselves are associated with a valve access identifier. The valve access identifier may include any suitable identifier which may be associated with the valve which is attempted to be manipulated. For instance the valve access identifier may include an identification of the respective oil battery, or the lock, or the valve itself. The valve access identifier does not have to be on the valve itself, but merely indicative in some manner of those valves which will be opened in order to remove oil. Verification of the individual is obtained and such verification results in an electrical signal being sent from a controller to the explosion proof solenoid valve of the respective valve which is attempted to be open. in addition to identifying if the individual has access, access may be denied depending on the time of day or other restrictive parameters.

As shown in FIGS. 1, 2 and 3, the locking. collar utilizes a housing adapted for integration with the mechanical valve of a oil transfer pipe. The locking collar is intrinsically safe and can be used in Class 1 Division 1 sites used to control access to mechanical valves that control the flow of crude oil, gasoline, natural gas, or other materials from a storage tank to a tanker truck, pipeline or other transportation mode. Communication at a site where the locking collar is installed is done either through a hard wired closed loop or a radio system. A base transmitter/receiving unit at or near the site communicates to a transceiver unit in the locking collar. The communications system at the site provides for internet access by using DSL, satellite transmission, cellular service, or CATV cable systems.

FIG. 8 illustrates a perspective view of one embodiment utilizing an air activated electro mechanical locking collar. In an embodiment, the locking collar utilizes a first electrical locking system and a second pneumatic locking system for limiting the flow of fluid through the transfer pipe to a waiting truck. The Locking collar consists of an explosion proof enclosure for housing the electronics carried by a container. The electrical components provide a first locking mechanism. The first locking mechanism prevents the second pneumatic locking system from operating unless the first locking mechanism is engaged. Preferably the electronic locking system is remotely operated. As shown in FIG. 8 an explosion proof radio antenna is adapted for receiving a remote signal for initiating the operation of the electronic locking system. In the preferred embodiment, the remote signal is not transmitted to the radio antenna unless a prior identity validation has occurred. This identity validation may include an access key card, a security code entered into an access panel or the like. Also, in the preferred embodiment, the locking collar includes a backup mechanical valve which may be accessed via a locked point of entry for manipulating a mechanical valve enabling the flow of fluid via the transfer pipe. An air pump is also carried by the explosion proof enclosure for utilization with the pneumatic locking system. The air pump is intended to prime the pneumatic locking system.

FIG. 8 illustrates the interior components of the air activated electro mechanical locking collar. The explosion proof enclosure houses the electronics within the general housing. As shown in FIG. 8, a pneumatic system which is primed via an air pump is energized to actuate a lock actuator piston which will move from a first position to a second position upon being driving by pneumatic power which operates the mechanical lock to pivot to a position unlocking the valve. The pneumatic system includes an input air tube for receiving air from the air pump, and output air tube which will receive air from a fluid accumulator. In order to remove the risk of an explosion occurring and purveying into the oil, flame arrestors are located within the air fluid path adjacent the explosion proof enclosure which houses the electronics. Accordingly, should the electronics emit a spark, the flame arrestors prevent the spark from traveling through the air locking system to the oil.

FIG. 9 illustrates the Explosion proof enclosure components. A first and second magnetic field sensitive switch is utilized in conjunction with a transceiver for controlling the operation of the one way air valve in the pneumatic locking system. The transceiver receives a remote authorization signal via the explosion proof antenna authorizing access to the oil for fueling a tanker. The pneumatic locking system includes the air pump which provides air to the air locking system. If permitted by the magnetic field sensitive switches, the one way air valve allows the air from the air pump to enter into an air accumulator. Once the air has accumulated a sufficient amount which would provide sufficient energy for actuation a lock actuator piston the air is released via an air solenoid via an air intake valve which exits the explosion proof enclosure and engages the lock actuator piston for releasing the lock which is engaged on the oil valve.

FIGS. 3 and 8 illustrate a secondary access locking system in the event the electronic system is inoperable. The secondary access locking system utilizes a key for removing a cover providing access to a manual lock which may be manipulated to an unlocked position. The manual lock engages the valve which is utilized for controlling the flow of fluid. The key utilized to remove the cover is retained within the lock requiring a second access system to be utilized for removing the enclosure of the locking system providing access to the key. This enables a manager to be aware that the system is either not working properly or has been accessed by a potential non-authorized individual.

In order insure that the user can get to the mechanical valve should power be off at a site or there was a system failure, a mechanical key system was designed. The key preferably goes into a sealed enclosure in the bottom of the metal cabinet. The key has a small metal cable attached to it that is long enough to allow the user to remove it and place it in the lock. Once the key is inserted in the key hole and turned, the mechanical lock will unlock so the cover that allows access to the mechanical valve handle securing the metal valve will pop up allowing the user to then open the mechanical valve. Once the key is inserted and the lock is turned, the key cannot be removed. To remove the key, management will have to come and remove a metal panel to get inside the metal cabinet to remove the key.

FIG. 9 illustrates the operation of a magnetic arm in combination with the magnetic field sensitive switches and the valve locking system. The oil valve is retained within an enclosure. The valve cover is hinged and is locked. The magnetic arm is utilized for both signaling to a remote user if the lock is locked or unlock. When the magnetic arm is in the down position, this signals that the lock is locked. This position enables current to flow to the solenoids through the magnetic field sensitive switch 1. When the magnetic arm is in the up position being engaged by the locking system, the current flow to the solenoid is terminated and also terminates current flow to the magnetic field sensitive switch 2 signaling that the lock is unlocked. The purpose of this Magnetic Field Switch #1 is to pass or not pass current to the Solenoid. The purpose of Magnetic Field Switch #2 is to allow current to pass or not pass to the transceiver unit and software to indicate whether the lock is locked or open. This feature is important in order to notify the user if the locking system is compromised by forcing the Electronic Lock Valve Cover up. If the lock is compromised an alert is sent by the software informing the user that the lock is in the unlocked position but no access code has been received by the software. When the Magnetic Arm is in the up position it terminates the current flow to the Solenoid by not allowing current to pass through Magnetic Field Sensitive Switch 1. Also when the Magnetic Arm is in this position Magnetic Field Sensitive Switch 2 terminates current flow signaling the lock is unlocked. When the Magnetic Arm is in the down position it allows current to flow to the

Solenoid through the Magnetic Field Sensitive Switch 1. Also when the Magnetic Arm is in this position Magnetic Field Sensitive Switch 2 allows current to flow through signaling the lock is locked. When the user is finished pumping the oil from the tank they will close the Locking Collar Valve Cover by pushing it down until the hasp on the inside of the valve cover engages the lock.

FIGS. 1, 2 and 3 illustrate the locking system in combination with the oil transfer pipe. The transfer of oil through the pipe is controlled by a mechanical vale which has a mechanical valve handle. The valve handle is inoperable as it is retained within a locking cover. The locking cover is controlled by locking system which is housed within an adjacent housing. The adjacent housing houses the pneumatic locking system which is controlled by an electronic access system. The electronics for operating the electronic access system are housed within an explosion proof enclosure. The locking cover is hinged and is actuated by the pneumatic system. When unlocked, the cover is allowed to be lifted enabling the mechanical valve handle to be operational and rotated 90 degrees for opening the valve and permitting oil to flow through the oil transfer pipe. When the transfer is complete, the handle is positioned to its original position and the cover is closed. Closing of the cover locks the system. The positioning of the cover to the closed position manipulates the magnetic arm to reset the pneumatic actuator and flush the air in the pneumatic system out the exhaust valve to the ambient environment discharging the system. In this position the magnetic arm is in position for signaling that the lock is locked.

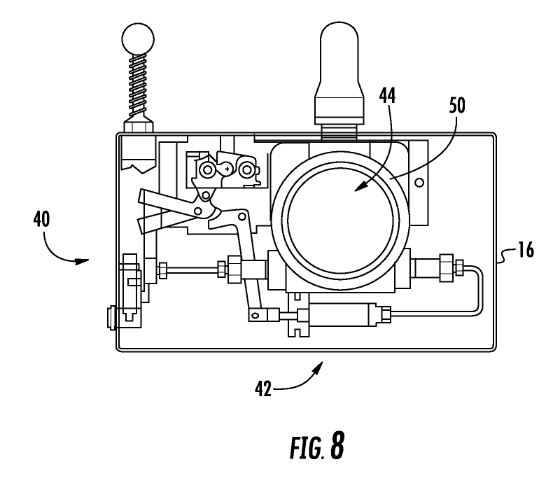

FIG. 7 illustrates an additional embodiment of the locking collar. The locking collar 10 includes housing which contains an explosion proof box 80 which houses the electronic solenoid 82 and associated electronics, an actuation trigger 86 which is moved when the electronic solenoid is turned on and locking mechanism 88. Locking mechanism 88 is similar to the construction provided with respect to FIG. 8. When the electronic solenoid is activated, a plunger or actuation trigger is motivated and engages locking mechanism 88.

Accordingly, in operation the system and method of restricting access to an oil transfer pipe is disclosed. Preferably the particular valve which will be manipulated has an identifier. An operator sends a request utilizing an operator identification code to a remote location. At the remote location, access for that particular operator for that particular valve is undertaken. If it is determined that the operator is allowed access to the valve a controller is authorized to send an electronic signal to an electronic solenoid. The electronic solenoid which is preferably housed in an explosion proof enclosure interacts with an actuator for motivating the actuator to engage a locking mechanism thereby releasing the lock.

We claim:

1. An access control system for an oil tank having a transfer pipe and a mechanical valve having a first position for permitting fluid flow through the transfer pipe and a second position for prohibiting fluid flow through said transfer pipe comprising:
a housing;
a lock for restricting movement of said mechanical valve from said second prohibiting position to said first permitting position;
an electronic solenoid valve contained within an explosion proof enclosure, said explosion proof enclosure enclosed within said housing; and
said electronic solenoid valve receiving an actuation signal for manipulating said lock to an unlock position enabling said mechanical valve to be transitioned from said second prohibiting position to said first permitting position if an operator is authorized to manipulate said valve.

2. The system of claim 1 including a valve access identifier identifying a valve which access is desired for opening the valve .

3. The system of claim 2 including an operator identification.

4. The system of claim 3 including an access database wherein said valve access identifier is associated with an operator identification for authorizing access to a particular valve to a particular operator.

5. The system of claim 1 including a controller for transmitting said actuation signal to said electronic solenoid valve.

6. The system of claim 5 including a valve access identifier for identifying which valve access is desired.

7. The system of claim 6 including an operator identification.

8. The system of claim 7 including an access database wherein valve identifiers are associated with operator identifications for authorizing access to a particular valve to a particular operator.

9. The system of claim 1 including a pivotal enclosure for enclosing said mechanical valve, said pivotal enclosure in combination with a locking mechanism preventing the pivotal enclosure from pivoting communicating with a locking mechanism defining said lock, said locking mechanism in communication with an actuator activated by said solenoid for releasing wherein said housing includes an interior, said interior carrying an explosion proof enclosure having an interior and said solenoid valve carried within said interior of said explosion proof enclosure.

10. The system of claim 1 including a pneumatic locking actuator, said pneumatic locking actuator including a reservoir for storing compressed air, said electronic solenoid releasing said stored compressed air from said reservoir for manipulating said lock enabling said valve to be opened.

11. A method of providing access to an oil battery having a valve with a valve handle for permitting oil to flow through a pipe for conveyance to a secondary storage vessel, said method comprising:
providing a lock inhibiting the movement of said valve handle;
providing an identifier identifying which valve is desired access;
providing an operator identification identifying an entity seeking access to said valve;
determining if said entity seeking access to said valve is authorized to have access; and
remotely unlocking said lock enabling said valve to be opened if it is determined that said entity seeking access to said valve is authorized to have access.

12. The method of claim 11 further including retaining said lock in a locked position prohibiting access to said valve if said entity is determined not to have access to said valve.

13. The method of claim 11 further including a database associating entities authorized to access a valve and a valve access identifier for correlating access between an entity and a valve.

14. The method of claim 11 wherein said valve access identifier is a bar code.

15. The method of claim 11 further including the steps of sending a digital signal to a access controller from said oil battery site, said digital signal representing said valve access identifier.

16. The method of claim 15 wherein said digital signal is produced by scanning a bar code.

17. The method of claim 15 wherein said digital signal is produced by scanning a QR code.

18. The method of claim 15 wherein said digital signal is produced by an operator sending a text message.

19. The method of claim 15 wherein said digital signal is sent via an electronic device having a transmitter.

20. The method of claim 19 wherein said digital signal is sent via a cell phone and an operator identifier is simultaneously sent.

21. The method of claim 11 wherein a visual image is taken of an individual requesting access to a valve and a determination based on said image is utilized for identifying if said individual has access to said valve.

22. The method of claim 11 further including a controller for sending an electronic signal to an electronic solenoid contained within an explosion proof enclosure for activating said lock.

23. A system for restricting access to a valve utilized for transferring oil from an oil reservoir to a secondary oil reservoir, said system comprising:
a housing;
a lock for restricting movement of said mechanical valve from said second prohibiting position to said first permitting position;
an electronic solenoid valve contained within an explosion proof enclosure, said explosion proof enclosure enclosed within said housing;
said electronic solenoid valve for receiving an actuation signal for manipulating said lock to an unlock position enabling said mechanical valve to be transitioned from said second prohibiting position to said first permitting position if an entity is authorized to manipulate said valve;
a controller for transmitting said actuation signal to said electronic solenoid valve;
an operator identifier identifying an entity seeking access to said valve;
a valve access identifier identifying which valve access is being sought;
and a database associating access rights between an operator and a valve access identifier; wherein
said controller sends an electronic signal to said electronic solenoid valve enabling access to said valve if said entity is verified to have access rights associated with said valve access identifier.
